(19) United States
(12) Patent Application Publication
(10) Pub. No.: US 2019/0134899 A1
(43) Pub. Date: May 9, 2019

(54) THREE DIMENSIONAL PRINTER WITH PRESSURE COMPENSATION FOR INDUCED STRESSES

(71) Applicant: 3D Systems, Inc., Rock Hill, SC (US)

(72) Inventors: Robert Mueller, San Diego, CA (US); Ben Wynne, Escondido, CA (US); Jamie Etcheson, San Diego, CA (US); Christopher Tanner, San Diego, CA (US)

(21) Appl. No.: 15/804,646

(22) Filed: Nov. 6, 2017

(51) Int. Cl. B29C 64/20; B29C 64/129; B29C 64/393; B33Y 10/00; B33Y 30/00; B33Y 50/02

(52) U.S. Cl. CPC B29C 64/20; B29C 64/129; B33Y 50/02; B33Y 10/00; B33Y 30/00; B29C 64/393

(57) ABSTRACT

A three dimensional (3D) printer generates 3D articles of manufacture through the selective hardening of light curable liquid resins. The 3D printer includes a vessel, a fixture, a movement mechanism, a light engine, a controllable pressure source, and a controller. The vessel contains light curable resin with a bottom portion including a transparent sheet. The light engine selectively illuminates a lower face of a 3D article of manufacture being formed through the transparent sheet. The fixture and movement mechanism selectively translate the lower face up and down which generates a varying pressure of the resin against a top surface of the transparent sheet. The controllable pressure source applies a gas pressure to a bottom surface of the transparent sheet to offset the varying pressure of the resin.

### CROSS REFERENCE TO RELATED APPLICATIONS

This non-provisional patent application claims priority to U.S. Provisional Application Ser. No. 62/425,842, Entitled “THREE DIMENSIONAL PRINTER WITH PRESSURE COMPENSATION FOR INDUCED STRESSES” by Robert Mueller et al., filed on Nov. 23, 2016, incorporated herein by reference under the benefit of U.S.C. 119(e).

### FIELD OF THE INVENTION

The present disclosure concerns an apparatus and method for fabrication of solid three dimensional (3D) articles of manufacture from energy curable materials. More particularly, the present disclosure concerns a way of improving the speed, dimensional accuracy, and component life in a 3D printer that selectively applies radiation to a photocurable liquid resin.

### BACKGROUND

Three dimensional (3D) printers are in rapidly increasing use. One class of 3D printers includes stereolithography (SLA) printers having a general principle of operation including the selective curing and hardening of radiation curable liquid resins. A typical SLA system includes a containment vessel holding the curable resin, a movement mechanism coupled to a support surface, and a controllable light engine. The movement mechanism positions the support surface such that a thin layer of uncured resin is between the light engine and the support surface. Then (1) the light engine selectively illuminates a portion of the thin layer, thereby curing it and (2) a layer of uncured resin is formed over the cured layer. Steps (1) and (2) are repeated until a 3D article of manufacture is fully formed.

In one SLA system embodiment the vessel includes a lower window facing the support surface. The light engine initially transmits light up through the lower window to the support surface on which resin is selectively hardened. The lowest extent of the hardened resin can be referred to as the “lower face” of the 3D article of manufacture being formed. The movement mechanism progressively moves the 3D article of manufacture upward to maintain a proper spacing for curing between the lower face and the lower window as the 3D article grows vertically.

One challenge is the “fouling” of the lower window with cured polymer. Ideally the polymer would only cure on the support surface and the lower face of the 3D article of manufacture. However, some polymer may cure upon the lower window. Over time, the cured polymer on the window will interfere with proper operation of the 3D printer. Also, the lower face may stick to the lower window. To overcome this problem, various solutions have been deployed including providing a release coating on the lower window and/or using chemical inhibitors to prevent the resin from curing on or near the lower window.

Another challenge with such as a system is how to maintain a supply of fresh resin near the lower window as it is being depleted by the hardening process. Yet another challenge includes stresses applied by the system on the cure window due to static and transient pressure of the resin against the cure window. What is desired is a complete solution that allows for long life use of the cure window and maximizing system speed.

### BRIEF DESCRIPTION OF THE FIGURES

FIG. 1 is a schematic block diagram of a three dimensional (3D) printing system incorporating a controllable pressure source for offsetting pressures generated against a transparent sheet forming the bottom of a vessel holding photocurable liquid resin.

FIG. 2 is an electrical block diagram of a 3D printing system including a first embodiment of a controllable pressure source.

FIG. 3 is a schematic diagram depicting a portion of a second embodiment of a controllable pressure source.

FIG. 4A is a cross sectional view depicting static pressures applied to a transparent sheet forming the bottom of a vessel for containing light curable liquid resin.

FIG. 4B is a cross sectional view depicting static and dynamic pressures applied to a transparent sheet forming the bottom of a vessel containing light curable liquid resin.

FIG. 5 is a flowchart representation of an operational method of a 3D printing system.

FIG. 6 is a timing diagram that is an embodiment corresponding to the flowchart of FIG. 5.

FIG. 7 is a schematic diagram depicting a portion of a third embodiment of a controllable pressure source.

### SUMMARY

In a first aspect of the disclosure, a three dimensional printer includes a vessel, a fixture, a movement mechanism, a controllable pressure source, and a controller. The vessel is for containing liquid photocurable resin and includes a transparent sheet through which the resin can be selectively illuminated. The transparent sheet includes an upper surface and an opposed lower surface. The fixture is for supporting a three dimensional (3D) article of manufacture whereby a lower face of the 3D article of manufacture is immersed in the resin in facing relation with the upper surface of the transparent sheet. The movement mechanism is for controllably translating the fixture whereby a distance between the lower face of the 3D article of manufacture and the upper surface of the transparent sheet can be varied. The controllable pressure source is for exerting a gas pressure over the lower surface of the transparent sheet. The controller is configured to (1) activate the movement mechanism to selectively vary the distance between the lower face of the 3D article of manufacture and the upper surface of the transparent sheet and (2) to control the pressure source to vary the gas pressure to compensate for variations in a force exerted by the resin upon the upper surface of the transparent sheet. In one embodiment the controller varies the gas pressure between positive and negative gauge pressure values.

In one implementation the controller includes a processor electrically coupled to a non-transient information storage device. The information storage device stores instructions that, when executed by the processor, perform various steps that include operating the movement mechanism and the controllable pressure source. In one embodiment the controller is contained in a single component. In a second embodiment the controller is contained in multiple components. In a third embodiment the controller is distributed among multiple components at different locations in the 3D printing system. In some embodiments the controller controls other components of the system including one or more of a light engine, a sensor, and other components of the 3D printing system.

In another implementation the transparent sheet includes an unsupported area of at least 50 square centimeters. In another embodiment the transparent sheet includes an unsupported area of at least 75 square centimeters. In another embodiment the transparent sheet includes an unsupported area of at least 100 square centimeters. In another embodiment the transparent sheet includes an unsupported area of at least 150 square centimeters. In another embodiment the transparent sheet includes an unsupported area of at least 200 square centimeters.

In yet another implementation the transparent sheet can have a thickness (along Z) in a range of 10 to 500 microns. In a more particular embodiment the transparent sheet can have a thickness in a range of 50 to 250 microns. In particular embodiments the transparent sheet can have a thickness of about 75 microns, about 100 microns, about 125 microns, about 150 microns, about 175 microns, or about 200 microns, to name a few examples.

In a further implementation the transparent sheet has a good optical clarity and is permeable to an inhibitor. In an exemplary embodiment the transparent sheet is formed from a Polytetrafluoroethylene (PTFE) and is permeable to oxygen. An example of such a PTFE material is Teflon® AF-2400 which is provided by Biogeneral.

In a yet further implementation the movement mechanism is configured to translate the fixture in a vertical direction. In one embodiment the movement mechanism can translate the fixture along more than one non-parallel axis.

In another implementation the 3D printing system includes a rigid transparent plate positioned below the lower surface of the transparent sheet whereby a conduit is formed between the lower surface of the transparent sheet and an upper surface of the rigid transparent plate. The controllable pressure source applies gas pressure to the conduit in order to apply gas pressure to the lower surface of the transparent sheet.

In yet another implementation the resin is a photocurable resin which is one of curable by ultraviolet (UV) light and curable by blue light. The gas applied by the controllable pressure source includes an inhibitor that diffuses through the transparent sheet and prevents the resin from curing on the upper surface of the transparent sheet. In one embodiment the inhibitor is oxygen.

In a second aspect of the disclosure, a three dimensional (3D) printer includes a vessel, a light engine, a fixture, a movement mechanism, a controllable pressure source, and controller. The vessel is for containing liquid photocurable resin and includes a transparent sheet through which the resin can be selectively illuminated. The transparent sheet includes an upper surface and an opposed lower surface. The fixture is for supporting a three dimensional (3D) article of manufacture whereby a lower face of the 3D article of manufacture is immersed in the resin in facing relation with the upper surface of the transparent sheet. The light engine is for applying a time varying image to the lower surface of the transparent sheet and up to the lower face of the 3D article of manufacture. The movement mechanism is for controllably translating the fixture whereby a distance between the lower face of the 3D article of manufacture and the upper surface of the transparent sheet can be varied. The controllable pressure source is for exerting a gas pressure over the lower surface of the transparent sheet. The controller is configured to: (a) operate the light engine to apply at least one image slice frame to the resin proximate to the lower face of the 3D article of manufacture while H is an operating distance; (b) operate the movement mechanism to translate the lower face of the 3D article of manufacture upwardly and away from the upper surface of the transparent sheet to allow resin to replenish the space between the lower face and the upper surface; and (c) concurrent with operating the movement mechanism, operate the pressure source to decrease the gas pressure applied to the lower surface of the transparent sheet to compensate for an increase in upward force applied by the resin to the transparent sheet. In one embodiment the gas pressure is decreased to a negative gauge pressure during at least part of step (c).

In one implementation the light engine is a projection system based upon a spatial light modulator (SLM) which is one of a micromirror array, a LCOS (liquid crystal in silicon) array, and a liquid crystal panel. In one embodiment the light engine is a DLP (digital light projector) system based upon a micromirror array.

In another implementation the light engine includes a light source that is one or more of: an ultraviolet (UV) light emitting diode (LED) array, a blue LED array, a UV laser diode array, and a blue laser diode array.

In yet another implementation the light engine applies a plurality of image slice frames during step (a). Each image slice frame selectively cures one layer of resin onto the lower face of the 3D article of manufacture.

In a further implementation and after concurrent steps (b) and (c) the controller is further configured to: (d) operate the movement mechanism to translate the lower face of the 3D article of manufacture downwardly until H is an operating distance and (e) concurrently with step (d), operate the pressure source to increase the gas pressure applied to the lower surface of the transparent sheet to compensate for a downward force applied by the resin to the transparent sheet. In one embodiment, the gas pressure is increased to a positive gas pressure during at least part of step (d).

In a third aspect of the disclosure, a method for manufacturing a three dimensional (3D) article of manufacture includes: (a) providing a containment vessel including a lower portion with a transparent sheet having an upper surface and a lower surface, the vessel containing a light curable resin; (b) positioning a lower face of a three dimensional article within the resin and in facing relation with the upper surface of the transparent sheet; (c) applying time varying light illumination to the lower surface of the transparent sheet which passes to the lower face and selectively solidifies resin onto the lower face; (d) applying a gas pressure to the lower face of the lower surface of the transparent sheet; (e) raising the lower face to allow fresh resin to more effectively flow in to a space between the lower face and the upper surface whereby the resin exerts an upward force upon the transparent sheet; and(f) concurrently with (e), lowering the gas pressure level to offset an upward force exerted by the resin upon the upper surface. In one embodiment the gas pressure is decreased from a positive gauge pressure to a negative gauge pressure in part (f).

In one implementation the method further includes (g) lowering the lower face to an operating distance enabling further solidification of resin onto the lower face whereby the resin exerts a dynamically varying downward force upon the transparent sheet and (h) concurrently with (g), raising the gas pressure level to offset the downward force. In one embodiment, the gas pressure is increased from a negative gauge pressure to a positive gauge pressure in progressing from step (f) through step (h).

### DETAILED DESCRIPTION OF THE PREFERRED EMBODIMENTS

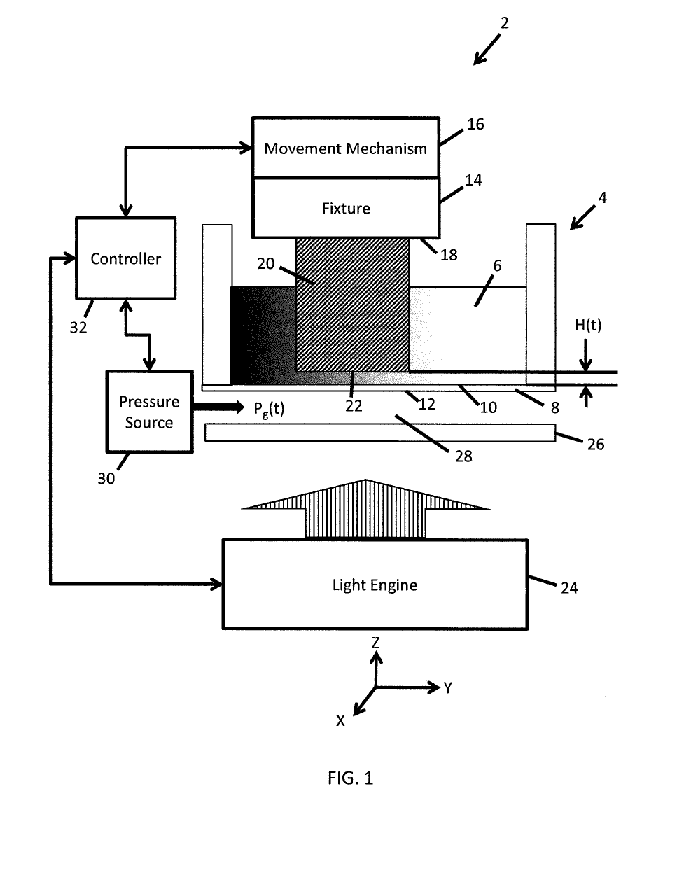

FIG. 1 is a schematic block diagram representation of an embodiment of a three dimensional (3D) printing system 2 that utilizes a novel apparatus and method for maximizing system speed, dimensional accuracy and component life. In describing system 2 various axes (XYZ) and directions will be used to depict positions and motions. Axes X, Y, and Z are mutually orthogonal. Axes X and Y are “lateral” or “horizontal” axes. Generally speaking, system 2 defines image slice frames that include ON pixels and OFF pixels as defined along the lateral axes. The ON pixels are those being hardened or polymerized for each image slice frame. The OFF pixels are left in a liquid state for each image slice frame.

The Z axis is a “vertical axis” along which a 3D article is translated. In some embodiments, the 3D object can be translated laterally in addition to vertically, but in a zone of hardening the motion is mostly or all vertical. For a given system 2 component, an upper portion (or top) is generally in the +Z direction relative to a lower portion (or bottom). Upward motion refers to motion in the +Z direction and downward motion refers to motion in the −Z direction.

3D printing system 2 includes a vessel 4 for containing curable resin 6. Vessel 4 includes a lower transparent sheet 8 having an upper surface 10 and a lower surface 12. Upper surface 10 faces in an upward (+Z) direction. Lower surface 12 faces in a downward (−Z) direction. Transparent sheet 8 is generally a thin polymer sheet supporting the weight of curable resin 6 and transient pressure forces exerted by curable resin 6 on the upper surface 10.

3D printing system 2 includes a fixture 14 coupled to a movement mechanism 16. Fixture 14 defines a support surface 18 upon which a 3D article of manufacture 20 is formed. The 3D article of manufacture 20 defines a growing lower face 22 that is in facing relation with the upper surface 10 of transparent sheet 8. A distance H is defined as the minimum vertical distance between 3D article of manufacture 20 and the upper surface 10 of transparent sheet 8. H can also be referred to as the distance between lower face 22 and upper surface 10 of transparent sheet 8. H is generally a function of time H(t) due to the operation of movement mechanism 16 and due to the progressive hardening of resin 6 to form layers of solidified material onto 3D article of manufacture 20.

The movement mechanism 16 is configured to move fixture 14 along vertical axis Z. Thus the movement mechanism 16 controllably varies the distance H(t) with time. In an alternative embodiment the movement mechanism 16 can move the fixture 14 in two or more axes. This would allow for the manufacture of certain unique geometries for the article of manufacture 20 that would otherwise not be possible for a given vessel 4.

3D printing system 2 includes light engine 24 for providing time varying radiation for the selective solidification of resin 6 through the transparent sheet 8 and to curable resin 6 that is proximate to the lower face 22 of 3D article of manufacture 20. In an exemplary embodiment, light engine 24 is a digital light projector (DLP) based light engine that modulates light from an ultraviolet (UV) light source. The UV light source can be an array of UV light emitting diodes (LEDs).

The light engine 24 generates a sequence of image frame slices. Each image frame slice defines the selective illumination and curing of a new layer of hardened resin that is added on to the lower face 22 of 3D article of manufacture 20. By adding a new layer of hardened resin onto the lower face 22 each image frame slice has the effect of reducing H(t) according to the slice thickness absent any Z-motion induced by movement mechanism 126.

The DLP system utilizes a micromirror array as a spatial light modulator (SLM). Each mirror of a micromirror array can be selectively tilted between an OFF state (no cure light reaching the resin) and an ON state (cure light reaching the resin for the associated pixel). The micromirror array defines a lateral array of pixels along X and Y. In one embodiment the array would be 1920 pixels along X and 1080 pixels along Y.

Other SLMs are possible such as liquid crystal display (LCD), liquid crystal on silicon (LCOS), and SLMs based on various principles including selective reflectance, selective attenuation, or selective interference. The light source can also vary and may include a laser, a diode laser, or an arc lamp to name a few examples.

3D printing system 2 includes a transparent plate 26 that is positioned below the transparent sheet 8. Transparent plate 26 can be a rigid glass plate. A conduit 28 is defined between transparent sheet 8 and transparent plate 26. The conduit contains a gas that is enriched with an inhibitor. The inhibitor diffuses through the transparent sheet 8 and prevents polymerization of resin 6 on or adjacent to the transparent sheet 8. This defines a “depletion zone” in the resin 6 that is adjacent to the upper surface 12 of transparent sheet 8 within which no polymerization of resin 6 takes place. Having this depletion zone prevents “fouling” of the upper surface 10 of transparent sheet 8 with hardened polymer which in turn increases the useful life of transparent sheet 8. This is important because transparent sheet 8 material can be expensive and its replacement can take the 3D printing system 2 out of service, decreasing its utilization and requiring expensive maintenance labor.

3D printing system 2 also includes a pressure source 30 that controls a gas pressure P_{g} within the conduit 28. This gas pressure P_{g} is defined in terms of a “gauge pressure” which is defined as a difference between the absolute conduit gas pressure and a surrounding atmospheric pressure. The gas pressure P_{g} (t) is shown as function of time because P_{g} is controlled to offset a pressure of resin 6 on the upper surface 10 of transparent sheet 8. This controlled pressure P_{g} (t) improves the flatness of the transparent sheet 8 which in turn improves print accuracy due to a more uniform zone of uncured resin 6 between upper surface 10 and lower face 22. This also has an effect of reducing damaging stresses upon transparent sheet 8, increasing the useful life of the transparent sheet 8.

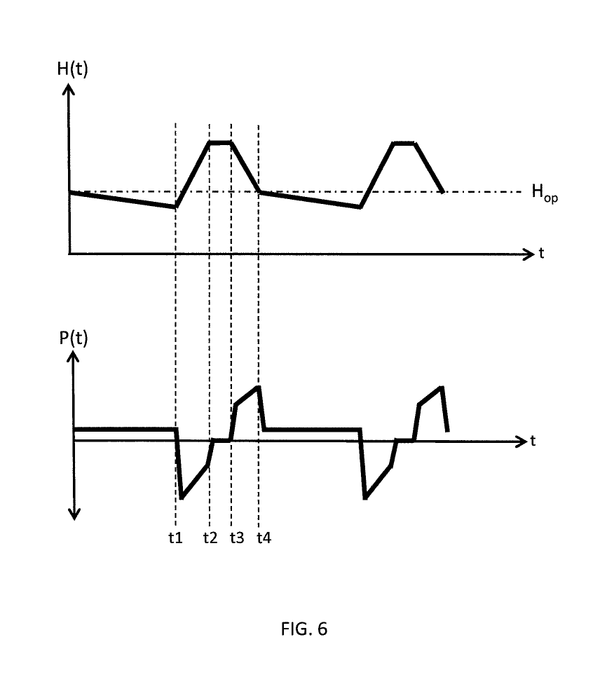

3D printing system 2 includes a controller 32 that is coupled to the movement mechanism 16, the light engine 24, and the pressure source 30. Controller 32 may include a single device at one location or multiple devices at different locations in 3D printing system 2. Controller 32 includes a processor in in electrical communication with an information storage device. The information storage device is a non-transient or nonvolatile storage device that stores instructions that, when executed by the processor, perform various process sequences that are defined by the operation of movement mechanism 16, light engine 24, pressure source 30, and other controllable or readable components that are in electrical or wireless communication with controller 32. Exemplary process sequences are described with respect to FIGS. 5 and 6.

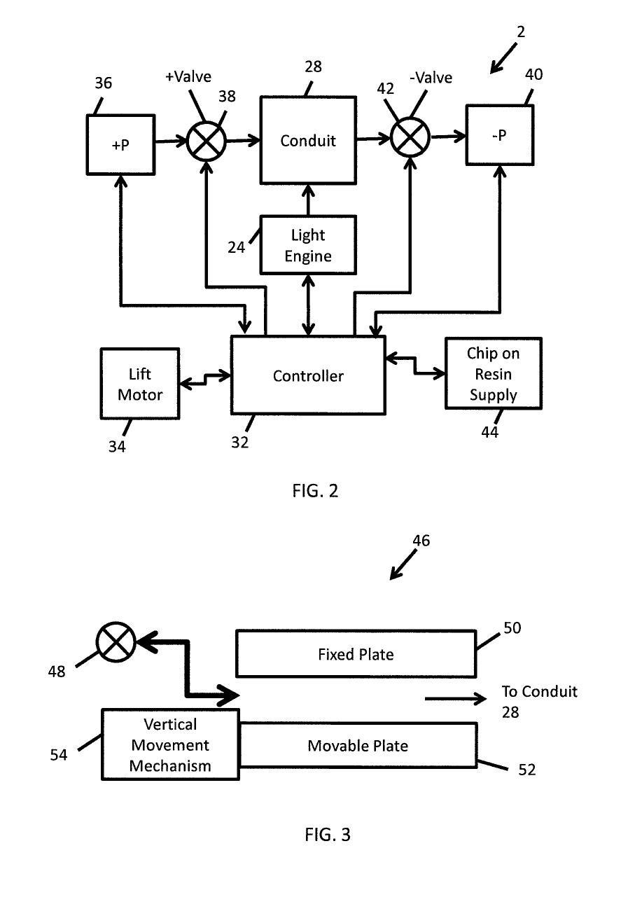

FIG. 2 is an electrical block diagram depicting an exemplary embodiment of 3D printing system 2. The embodiment of FIG. 2 is similar to that of FIG. 1 except for the disclosure of a particular pressure source 30 and a chip on a resin supply 44. The controller 32 is in electrical communication with light engine 24, lift motor 34, positive pressure vessel 36, positive pressure valve 38, negative pressure vessel 40, negative pressure valve 42, and chip 44.

Positive pressure vessel 36 and negative pressure vessel 40 are pressure vessels whose interiors are maintained with positive (+P) and negative (−P) gauge pressures respectively. The pressure values +P and −P define a maximum range of gas pressures to apply to the conduit 28. Fast selective opening and closing of valves 38 and 42 enable a selection of a gauge pressure versus time to be applied to the conduit 28 within the range of −P to +P and limited by the speed and volumetric capacities of valves 38 and 42.

Referring to FIG. 1, one embodiment of movement mechanism 16 includes a motorized lead screw. The motor 34 can be referred to as a “lift motor” that turns the lead screw to provide upward and downward motion and positioning for fixture 14. Controller 32 thus controls motor 34 to in turn control H(t). Movement mechanism 16 may include other devices such as position sensors that are not shown for sensing a position of fixture 14. In alternative embodiments movement mechanism 16 can incorporate other components such as rack and pinion systems, motorized cam surfaces, solenoid actuators, and piezoelectric actuators, to name a few examples.

The chip on resin supply 44 stores information about resin 6. This information includes resin-specific information such as resin density, cure rate, and rheology. Rheology information can include viscosity and the temperature dependence of various parameters including viscosity and cure rate. The controller can utilize this information to optimize various parameters employed in forming article of manufacture 20 to maximize a rate of article formation and to minimize stress being applied to transparent sheet 8. The chip on resin supply 44 can be in direct or wireless communication with controller 32.

FIG. 3 depicts another embodiment of a mechanism 46 for modulating pressure in conduit 28. Mechanism 46 can form a portion of pressure source 30 and includes a controllable valve 48, a fixed plate 50, a moveable plate 52, and a vertical movement mechanism 54. Valve 48 and vertical movement mechanism 54 are under control of controller 32. With valve 48 the controller 32 operates vertical movement mechanism 54 to move movable plate 52 toward fixed plate 50 in order to increase pressure in conduit 28. Alternatively the controller 32 can operate vertical movement mechanism 54 to move movable plate 52 away from fixed plate 50 in order to decrease pressure in conduit 28. In one embodiment the vertical movement mechanism 54 and movement mechanism 16 both generate motion by the action of a lead screw. One advantage of this means of modulating pressure is that they can both have about the same response rate. The pitch of the lead screw and areas of the fixed and movable plates can be selected to optimize resolution and rate of pressure changes applied to conduit 28.

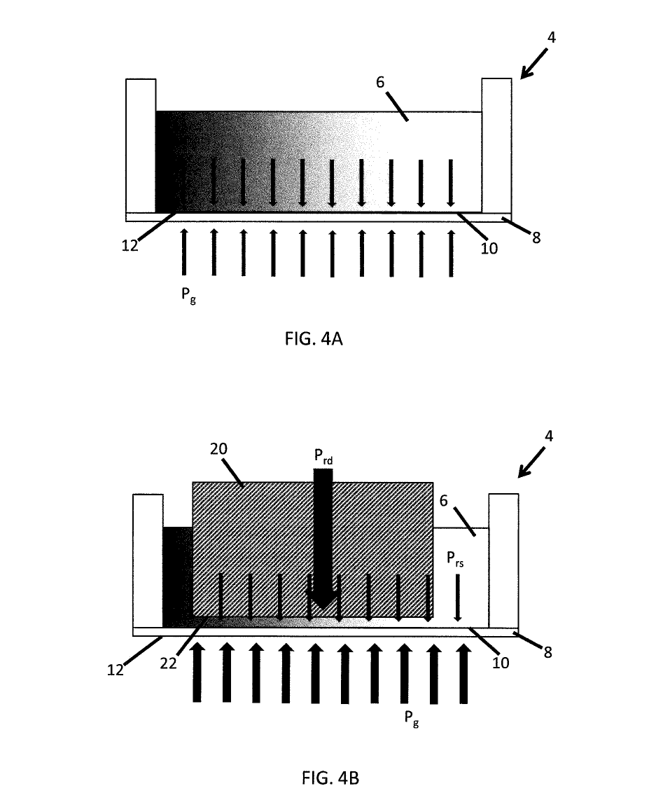

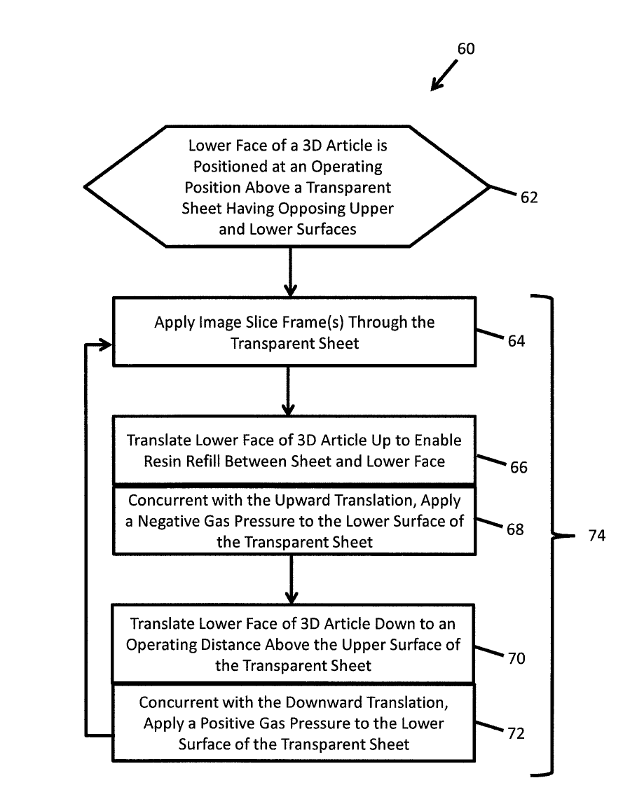

FIGS. 4A and 4B are side cross sectional views of vessel 4 that are used to illustrate static and dynamic gauge pressures respectively. FIG. 4A depicts a vessel 4 having transparent sheet 8 with resin 6. Resin 6 generates a fluid gauge pressure Pᵣₛ across the upper surface 10 of transparent sheet 8. The gauge pressure Pᵣₛ as depicted is the “static” fluid pressure because it is based on the static height of the resin fluid column above the upper surface 10. If a top surface of the resin is only 10-20 millimeters (mm) above the upper surface 10, then this pressure is fairly small. However, even a small pressure will cause some deflection or bow of transparent sheet 8 and this may be enough to affect the attenuation of light between the transparent sheet 8 and the lower face 22 (see FIG. 1) being fabricated. There is a desire to greatly increase the area of the transparent sheet 8 to accommodate 3D articles of manufacture having a larger cross sectional area. The downward bow of the transparent sheet 8 is then a deleterious function of increased area. In the static case pressure source 30 can be used to provide a static compensating pressure P_{g} to offset the static fluid pressure of resin 6.

In various embodiments the transparent sheet can have a thickness (along Z) in a range of 10 to 500 microns. In a more particular embodiment the transparent sheet can have a thickness in a range of 50 to 250 microns. In particular embodiments the transparent sheet can have a thickness of about 75 microns, about 100 microns, about 125 microns, about 150 microns, about 175 microns, or about 200 microns, to name a few examples.

In various embodiments the transparent sheet has a good optical clarity and is permeable to an inhibitor. In an exemplary embodiment the transparent sheet is formed from a Polytetrafluoroethylene (PTFE) and is permeable to oxygen. An example of such a PTFE material is Teflon® AF-2400 which is provided by Biogeneral.

In an exemplary embodiment the transparent sheet is 80 microns thick (along Z) and has lateral dimensions of 100 mm in X and 60 mm in Y. This is an area of about 60 square centimeters The there is a desire to increase the area to about 240 square centimeters or more. There may also be a desire to utilize a greater fluid column. This would increase the need to be able to compensate for the static fluid pressure Pᵣₛ with pressure P_{g}.

FIG. 4B is similar to FIG. 4A except that 3D article of manufacture 20 is being moved into position in which lower face 22 is being moved into close proximity with the upper surface 10 of transparent sheet 8. As this is done, uncured resin has to escape from between lower face 22 and upper surface 10. This can generate a large dynamic pressure P_{rd} against upper surface 10. This pressure P_{rd} can be much higher than the static fluid pressure Pᵣₛ. A considerably larger gas pressure P_{g} is therefore applied to the lower side 10 of transparent sheet 8 to counteract the large dynamic resin pressure P_{rd}. The gas pressure P_{g}(t) is varied with time to offset the very transient dynamic resin fluid pressure P_{rd}.

Not shown is a case in which the article of manufacture 20 is translated upwardly from a position of close proximity between the lower face 22 and the upper surface 12 of transparent sheet 8. This upward motion can exert a large upward dynamic resin gauge pressure P_{rd} on the upper surface 10 of transparent sheet 8. To offset this, the pressure source 30 can exert a negative gauge pressure P_{g} to the lower surface 12 of transparent sheet 8.

As may be apparent from this discussion the dynamic resin pressure P_{rd} is an important factor influencing sag and useful life of the transparent sheet 8. This in turn influences dimensional accuracy (affected by sag) and cost and maintenance of 3D printing system 2. The dynamic resin pressure is primarily affected by key variables that include translation velocity, H at an operating distance, resin viscosity, and the geometry and dimensions of the 3D object of manufacture 20 at or near the lower face 22.

The translation velocity of the lower face 22 induces the dynamic resin pressure P_{rd} on the transparent sheet 8 in the direction of the velocity. A higher velocity will result in a greater pressure P_{rd}.

The pressure P_{rd} rises rapidly as the distance H(t) decreases because resin has to “fill in” or “escape” from between the transparent sheet 8 and the lower face 22 through the smallest cross sectional area. The minimum value of H(t) in translation is an a “operating distance” Hₒₚ at which the light engine 24 is delivering image slice frames to the lower face 22 upon which resin is polymerized. Thus motion of the lower face 22 toward or away from the operating distance Hₒₚ generates the greatest force upon transparent sheet 8.

The viscosity of the resin 6 also affects P_{rd}. A rising viscosity increases P_{rd}. Viscosity can be a function of temperature. In an exemplary embodiment the chip 44 stores parameters that are indicative of a viscosity of resin 6 as a function of temperature. In this embodiment the system includes a sensor (not shown) that generates a signal indicative of the temperature of resin 6. The controller 32 reads the data from the chip 44 and the sensor and thereby determines an estimate for the viscosity. This may be determined from a first lookup table (LUT) that correlates viscosity with temperature and is generated based upon the data from the chip 44.

Finally the cross sectional area and geometry of 3D article of manufacture 20 near lower face 22 will affect the pressure P_{rd} and total force exerted on the transparent sheet 8. A larger cross sectional area will generate more force.

In one embodiment, the controller 32 stores lookup tables (LUTs) to select optimal velocities and the pressure P(t) that is applied to the lower side 12 of transparent sheet 8. In general, as the viscosity and cross sectional area (of the 3D article of manufacture near the lower face 22) increase the translation velocity of the lower face 22 toward or away from an operating distance will be decreased based upon a second LUT.

The applied pressure P_{g} is based upon a third LUT that correlates P_{g}(t) with translation velocity, H(t), resin viscosity, geometry of the 3D article of manufacture, and the cross sectional area of the 3D article of manufacture proximate to lower face 22. In general, P_{g}(t) will rise with increasing velocity, decreasing H(t), resin viscosity, and a larger cross sectional area proximate to lower face 22.

FIG. 5 is a flowchart representation of a method 60 by which system 2 produces a 3D article of manufacture 20 with emphasis on steps and factors that reduce sag and damage to the transparent sheet 8. Method 60 is carried out by the controller 32 operating upon the movement mechanism 16, the light engine 24, and the pressure source 30. Method 60 begins with the lower face 22 of the 3D article of manufacture positioned an operating position Hₒₚ that is proximate to the upper surface 10 of transparent sheet 8 according to step 62.

According to step 64, at least one image slice frame is applied by the light engine 24 resin proximate to the lower face 22 of the 3D article of manufacture 20. Step 64 results in selective curing and hardening of the resin 6 to add a layer of material to 3D article of manufacture. At the same time, inhibitor (e.g., oxygen) that diffuses from the conduit 28 to the upper surface 10 of flexible sheet 8 prevents resin from hardening onto the upper surface 10. In one embodiment the number of image slice frames can vary between 1 and 10 in step 64. As this occurs, the spacing H(t) will decrease in an amount equal to the thicknesses of the added layers.

In an exemplary embodiment, the distance H(t) is incrementally adjusted after during step 64 in order to maintain H(t)=Hₒₚ during step 64. The controller 32 alternates between sending image frame(s) to light engine 24 and operating movement mechanism 16 to incrementally raise the lower face 22 to compensate for incremental added thickness onto the lower face 22. Thus the lower face 22 is raised incrementally after each of one or more image slice frame(s) sent to the light engine 24.

According to step 66, the lower face 22 is translated upwardly allow resin 6 to refill a space between the transparent sheet 8 and the lower face 22. This motion brings the lower face 22 above an operating distance. Step 68 is performed concurrently with step 66. According to step 68, the gas pressure P_{g} is decreased to offset an upward pressure applied by the resin 6 on the upper surface 10 of the transparent sheet 8. In an exemplary embodiment the applied gas pressure P_{g} has a negative gauge pressure to offset an otherwise net upward force on transparent sheet 8.

Between steps 68 and 70 there may be a small delay (not shown) to allow the resin 6 to find at least partial equilibrium. In other embodiments there is no delay between steps 68 and 70.

According to step 70, the lower face 22 is translated downwardly to an operating distance Hₒₚ. Step 72 is performed concurrently with step 70. According to step 72, the gas pressure Pg is increased to offset a downward pressure applied by resin 6 upon the upper surface 10 of the transparent sheet 8. In an exemplary embodiment the gas pressure P_{g} switches from a negative gauge pressure for steps 66 and 68 to a positive gauge pressure for steps 70 and 72.

The sequence of steps 64 to 72 can be referred to as one “cycle” 74 in the fabrication of a 3D article of manufacture 20. Cycle 74 is repeated until the 3D article of manufacture is fully formed. Then (not shown) the movement mechanism 16 moves the then complete 3D article of manufacture 20 out of the resin 6 for removal from fixture 14.

FIG. 6 includes two graphs that are exemplary timing diagrams that correspond to the flowcharts of FIG. 5. The graph of H(t) versus t depicts the distance H of the lower face 22 above the upper surface 10 of transparent sheet 8 as a function of time. The graph of P(t) versus t depicts the pressure applied by pressure source 30 to the lower surface 12 of transparent sheet 8 as a function of time. The horizontal dashed line in the top graph depicts the initial operating distance Hₒₚ at t=0 according to step 62 of method 60. The vertical dashed lines intended to synchronize the times between the H(t) and P(t) graphs. The vertical dashed lines are indicative of times t1, t2, t3, and t4 in going from left to right. The time between t=0 to t=t4 is one cycle 74 for producing the 3D article of manufacture.

The initial value of Hop at t=0 can vary. In an exemplary embodiment Hop is in a range of 50 to 500 microns (μm). In a more particular embodiment Hₒₚ is in a range of 100 to 300 microns.

The time between t=0 (the vertical axes) and t=t1 corresponds to step 64 of method 60. The graph for H(t) slopes downwardly to depict the distance between the lower face 22 of the 3D article of manufacture 20 becoming closer to the upper surface 10 of transparent sheet 8. This is because the image slice frame(s) from light engine 24 is(are) adding thickness onto the lower end 22. During this time period the pressure source 30 is applying a constant positive gauge pressure to the lower surface 12 of transparent sheet 8 to offset the weight of resin 6.

In an exemplary embodiment of step 64, the lower face 22 is incrementally raised during step 64 as discussed above. Then the graph (t) would define a horizontally trending sawtooth pattern between t=0 and t=t1.

In some embodiments, between t=0 and t=t1, H(t) can decrease by 10 to 400 microns. In more particular embodiments, H(t) can decrease by 50 to 200 microns. In an exemplary embodiment H(t) can decrease by about 100 microns. But, as indicated, in an exemplary embodiment H(t) oscillates but remains close to H(t)=Hₒₚ between t=0 and t=t1.

The time between t=t1 and t=t2 corresponds to steps 66 and 68 of method 60. The graph of H(t) slopes upwardly to indicate the lower end 22 of the article of manufacture 20 rising up and away from the upper sheet 10 of transparent sheet 8. The resin 6 viscous drag generates an upward force on the transparent sheet 8. The graph of P(t) indicates an offsetting pressure that is applied to the transparent sheet to offset the effect of the upward pressure. The offsetting pressure is depicted as a negative gauge pressure. As H(t) gets larger the pressure P_{g} becomes less negative because the viscous force will tend to decrease with distance.

The change in H(t) between t1 and t2 is primarily a function of the cross sectional geometry the 3D article of manufacture 20 near the lower face 22. In some embodiments the change in H(t) may range from as little as 100 microns to as much as 5000 microns. A lookup table (LUT) can be used to determine the change in H(t) as the 3D article of manufacture is being formed.

The time between t=t2 and t=t3 corresponds to a time between steps 68 and 70 of method 60. This time may be zero in some embodiments.

The time between t=t3 and t=t4 corresponds to steps 70 and 72 of method 60. The graph of H(t) slopes downwardly to indicate the lower face 22 of the article of manufacture moving back to an operating distance Hₒₚ. The resin 6 applies an increasing downward force upon the upper surface 10 of the transparent sheet 8. Therefore pressure P(t) increases to a positive gauge pressure which is increased as the lower face 22 approaches the upper surface 10 of transparent sheet 8.

After time t=t4 the gauge pressure decreases to a lower positive value for offsetting the weight of resin 6. The cycle 74 repeats itself until the 3D article of manufacture is complete.

The timing diagrams of FIG. 6 are not meant to be exact or scaled but are meant to illustrate the principles of operation. The actual graphs of H(t) and P(t) can be generated from LUTs based on input variables including the resin viscosity and the geometry of the 3D article of manufacture proximate to the lower face 22. Thus, for a given 3D article of manufacture 20, the graphs may change from one cycle to the next to compensate for variables such as cross sectional areas, geometries, and temperature.

In one embodiment, the transparent sheet 8 may include a stress or strain gauge sensor that can be used by controller 32 for closed loop control of the pressure P(t). LUTs may still be used as a starting point but with closed loop correction. In other embodiments, the controller 32 may provide slow incremental continuous motion during step 64.

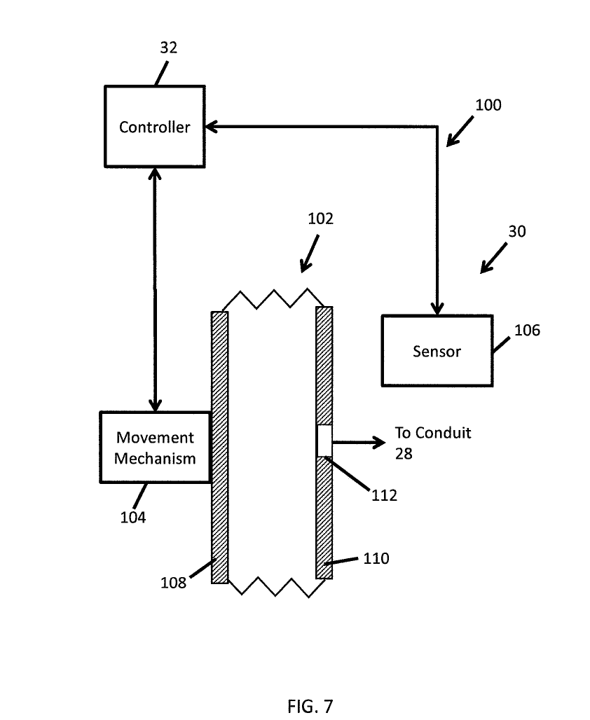

FIG. 7 is a schematic representation of a third embodiment 100 of a portion of the three dimensional printing system 2 incorporating a controllable pressure source 30. The controllable pressure source 30 includes a bellows apparatus 102, a movement mechanism 104, and a sensor 106. The movement mechanism 104 is configured to controllably vary the volume of bellows 102. In one embodiment the movement mechanism 104 utilizes a lead screw drive that moves movable plate 108 relative to a fixed plate 110. A gas inlet/outlet 112 fluidically couples an interior or internal volume of the bellows apparatus 102 to the conduit 28. A sensor 106 is disposed to monitor a pressure or displacement. In one embodiment, sensor 106 senses a differential pressure exerted on the transparent sheet 8. In another embodiment, the sensor 106 senses a displacement of transparent sheet 8.

During the cycle 74 (FIG. 5) the controller 32 operates the movement mechanism 104 to effect steps 68 and 72. In one embodiment, the controller 32 can perform real time monitoring of information from sensor 106 and can adjust steps 68 and 72 in real time accordingly. In another embodiment, the controller 32 can utilize data gathered from sensor 106 and update a LUT stored on controller 32 that enables a more pressure compensation.

Although element 102 is described as a “bellows” 102, it is to be understood that 102 is generally a variable volume 102 that is modulated by the movement mechanism 104. In another embodiment the variable volume 102 can be a collapsible rubber dome or other shape that performs the function of pressure modulation in conduit 28. In yet another embodiment the variable volume may incorporate a very small orifice that provides a slow leak. The variable volume 102 would have a zero gauge pressure until movement mechanism either expands or contracts the variable volume 102.

The specific embodiments and applications thereof described above are for illustrative purposes only and do not preclude modifications and variations encompassed by the scope of the following claims.

What we claim is:

1. A three dimensional (3D) printer comprising:
a vessel for containing a liquid resin, the vessel having a transparent sheet through which the resin can be illuminated, the transparent sheet having an upper surface and an opposed lower surface;
a fixture for supporting a 3D article of manufacture whereby a lower face of the 3D article of manufacture is immersed in the resin in facing relation with the upper surface of the transparent sheet;
a movement mechanism for controllably translating the fixture whereby a vertical distance between the lower face of the 3D article of manufacture and the upper surface of the transparent sheet can be varied;
a controllable pressure source for exerting a gas pressure over the lower surface of the transparent sheet; and
a controller configured to:
activate the movement mechanism to selectively vary the distance between the lower face and the upper surface; and
control the pressure source to vary the gas pressure to compensate for variations in a force exerted by the resin upon the upper surface of the transparent sheet.

2. The 3D printer of claim 1 wherein the movement mechanism can translate the fixture along more than one non-parallel axes.

3. The 3D printer of claim 1 further comprising a transparent plate disposed below the transparent sheet to define a conduit therebetween which is pressurized by the controllable pressure source.

4. The 3D printer of claim 1 wherein the pressure source generates a dynamically varying gas pressure against the lower surface of the transparent sheet to offset a dynamically varying resin pressure exerted on the top surface of the transparent sheet.

5. The 3D printer of claim 4 wherein the dynamically varying gas pressure varies between a negative gauge pressure and a positive gauge pressure.

6. The 3D printer of claim 1 wherein the pressure source includes a variable volume and a second movement mechanism coupled to the controller, the variable volume is fluidically coupled to the opposed lower surface of the transparent sheet, the controller operates the movement mechanism to modulate an internal volume of the variable volume which thereby modulates the gas pressure applied to the lower surface of the transparent sheet.

7. The 3D printer of claim 6 wherein the pressure source further includes a sensor that responds to a differential pressure across the transparent sheet, the sensor provides a signal to the controller for improving accuracy of the pressure compensation.

8. The 3D printer of claim 1 wherein the pressure source includes a controllable valve that couples the lower surface of the transparent sheet to a pressure vessel, the controller operates the valve to modulate a pressure exerted on the lower surface of the transparent sheet.

9. The 3D printer of claim 8 wherein the pressure vessel includes two pressure vessels including a first pressure vessel with a positive internal gauge pressure and a second pressure vessel having a negative internal gauge pressure, the controllable valve includes two valves that separately fluidically couple the two pressure vessels to the lower surface of the transparent sheet.

10. A three dimensional printer comprising:
a vessel for containing a curable resin and having a transparent sheet through which the resin can be selectively illuminated, the transparent sheet having an upper surface and an opposed lower surface;
an fixture for supporting a 3D article of manufacture whereby a lower face of the 3D article of manufacture is immersed in the resin in facing relation with the upper surface of the transparent sheet;
a light engine for applying a time varying image to the lower surface of the transparent sheet and up to the lower face of the article of manufacture;
a movement mechanism for controllably translating the fixture whereby a vertical distance H between the lower face and the upper surface can be varied;
a controllable pressure source for exerting a gas pressure over the lower surface of the transparent sheet; and
a controller configured to:
(a) operate the light engine to apply at least one image slice frame to the resin proximate to the lower face of the article of manufacture while H is an operating distance;
(b) operate the movement mechanism to translate the lower face of the 3D article of manufacture away from the upper surface of the transparent sheet to allow resin to replenish the space between the lower face and the upper surface; and
(c) concurrent with operating the movement mechanism, decreasing the gas pressure applied to the lower surface of the transparent sheet to compensate for an increase in upward force applied by the resin to the transparent sheet.

11. The 3D printer of claim 10 wherein the movement mechanism can translate the fixture along more than one non-parallel axis.

12. The 3D printer of claim 10 further comprising a transparent plate disposed below the transparent sheet to define a conduit therebetween which is pressurized by the controllable pressure source.

13. The 3D printer of claim 10 wherein the controller applies a plurality of image slice frames during step (a).

14. The 3D printer of claim 10 wherein the gas pressure is decreased to a negative gauge pressure during step (c).

15. The 3D printer of claim 10 further comprising: (d) operating the movement mechanism to translate the lower face of the 3D article of manufacture downwardly until H is an operating distance and (e) concurrently with step (d), operating the pressure source to increase the gas pressure applied to the lower surface of the transparent sheet to compensate for a downward force applied by the resin to the transparent sheet.

16. The 3D printer of claim 15 wherein the gas pressure changes from a negative gauge pressure to a positive gauge pressure from step steps (c) through step (e).

17. A method of manufacturing a three dimensional (3D) article of manufacture comprising:
(a) providing a containment vessel including a lower portion with a transparent sheet having an upper surface and a lower surface, the vessel containing a light curable resin;
(b) positioning a lower face of a three dimensional article within the resin and in facing relation with the upper surface of the transparent sheet;
(c) applying time varying light illumination to the lower surface of the transparent sheet which passes to the lower face and selectively solidifies resin onto the lower face;
(d) applying a gas pressure to the lower face of the lower surface of the transparent sheet;
(e) raising the lower face to allow fresh resin to more effectively flow in to a space between the lower face and the upper surface whereby the resin exerts an upward force upon the transparent sheet; and
(f) concurrently with (e), lowering the gas pressure level to offset an upward force exerted by the resin upon the upper surface.

18. The method of claim 17 wherein the gas pressure is decreased to a negative gauge pressure in step (f).

19. The method of claim 17 further comprising (g) lowering the lower face to an operating distance enabling further solidification of resin onto the lower face whereby the resin exerts a dynamically varying downward force upon the transparent sheet and (h) concurrently with (g), raising the gas pressure level to offset the downward force.

20. The method of claim 19 wherein the gas pressure is increased from a negative gauge pressure to a positive gauge pressure in progressing from step (f) through step (h).
